(19) United States
(12) Patent Application Publication
(10) Pub. No.: US 2009/0173309 A1
(43) Pub. Date: Jul. 9, 2009

(54) Piston For an Internal Combustion Engine Having Two Ring Grooves Wherein One Ring Groove Has A Ring Carrier

(75) Inventors: Emmerich Ottiliczky, Forchtenberg-Ernsbach (DE); Ralf Buschbeck, Möckmühl (DE); Willi Sikorsky, Neckarsulm (DE); Albrecht Roloff, Untereisesheim (DE)

Correspondence Address: YOUNG & BASILE, P.C., 3001 WEST BIG BEAVER ROAD, SUITE 624, TROY, MI, 48084, US

(73) Assignee: KS Kolbenschmidt GMBH, Neckarsulm (DE)

(21) Appl. No.: 12/296,251

(22) PCT Filed: Apr. 5, 2007
(86) PCT No.: PCT/EP2007/003096

§ 371 Date: Jan. 30, 2009

(30) Foreign Application Priority Data
Apr. 8, 2006 (DE) 10-2006-016-630.2

(51) Int. Cl. F02F 3/00; F16J 9/12

(52) U.S. Cl. 123/193.6; 277/456

(57) ABSTRACT

A piston for an internal combustion engine has a piston upper part which has a ring field having a plurality of ring grooves, and a piston lower part wherein there is provision for the ring field to have precisely two ring grooves with at least the upper ring grooves having a ring carrier.

Piston for an internal combustion engine with two ring grooves wherein one ring groove has a ring carrier.

The invention relates to a piston for an internal combustion engine consisting of a piston upper part having a ring belt with several ring grooves and a piston lower part in accordance with the features of the preamble of claim 1.

In the case of pistons for internal combustion engines, it is basically know that their piston upper part (also called the piston crown or piston head) has a ring belt. Such a ring belt normally comprises three ring grooves which are disposed one behind the other in the axial direction of motion of the piston. Gas-sealing and oil scraper rings are inserted into these three grooves which effect a separation of the combustion chamber from the lower part of the engine in which motor oil circulates. The use of three ring grooves is disadvantageous because increased manufacturing costs must be involved to form the three ring grooves in the piston upper part, usually by metal-removing machining. In addition, there is increased assembly complexity and an associated multiplicity of parts because three piston rings, occasionally of different geometries, must be kept in stock and assembled. In addition, the use of such a piston with three piston rings in the internal combustion cylinder results in increased coefficients of friction so that fuel consumption is disadvantageously increased. In addition, three piston rings represent high weight with increased space requirements. Increases in performance and variable valve control require an increase in ring heights, where the space is no longer sufficient with a given compression height.

The object of the invention is, therefore, to provide a piston for an internal combustion engine which is improved compared with the prior art and results in particular in reduced frictional losses, optimized durability and a savings in weight and costs.

This object is achieved by the features of patent claim 1.

In accordance with the invention, the ring belt has exactly two ring grooves and at least the upper ring groove encloses a ring carrier. Because of the presence of only two ring grooves and the gas-sealing and oil scraper rings inserted there, frictional losses are reduced since a smaller surface of the oil scraper rings is running on the inner cylinder wall of the internal combustion engine. In addition, the weight of the complete piston is reduced because there is one fewer piston ring compared with the prior art.

For the same reason there is a cost saving and assembly is improved since, while achieving the same effect, only two oil scraper rings have to be installed and the necessary ring grooves provided.

The upper ring groove facing the engine combustion chamber has a ring carrier which may be of the same material or of a different material than the material of the piston upper part. Due to the pre-manufacturable ring carrier which is formed at the time the piston is cast, there is a finished cast ring groove available as a result of which the locating area for the ring groove can be stronger compared with the material of the piston upper part in order to better absorb the forces in the area of the top land and the temperatures prevailing there.

In a particularly advantageous way, the ring carrier consists of a steel material, or Ni-resist if the piston upper part consists of a lightweight material.

In a further development of the piston, the lower ring also comprises a ring carrier. Thus each of the two ring grooves encloses a ring carrier, thereby increasing strength and reducing manufacturing costs, furthermore metal-removing machining to introduce the ring grooves is no longer needed. However, in this case it is necessary to manufacture the ring carriers separately before the piston is cast, place them in the casting tool and then to surround them with the casting melt by filling the casting tool.

In a further development of the invention, at least the one ring carrier of the upper ring groove, but in particular both ring carriers are completely surrounded by the material of the piston upper part. This has the advantage of increased strength since the ring carriers (with the exception of the outward facing surface in which the grooves are located) are surrounded by the material of the piston upper part and can be adequately supported.

In a further development of the piston, the at least one ring carrier undergoes the Al-Fin process. This Al-Fin coat on the ring carrier in those areas in which the ring carrier is enclosed by the material of the piston upper part has the advantage that the bond between the ring carrier and the material of the piston upper part surrounding it is thereby improved, which additionally increases strength. This is of particular advantage when, in accordance with a further embodiment, at least the piston upper part, specifically the entire piston, consists of a light-alloy material and the ring carrier consists of a steel material.

It is thus possible that at least the piston upper part, more specifically the entire piston, consists of a light-alloy material (such as aluminum for example) while the ring carrier is produced from a steel material. Alternatively, similar material pairings (piston upper part and ring carrier of steel or piston upper part and ring carrier of aluminum) are not excluded.

The invention thus makes available a piston with only two ring grooves, preferably of a light-alloy material, for diesel or gasoline internal combustion engines, wherein at least the upper ring groove is provided with a ring carrier whereby in an advantageous way there is a reduction of frictional losses, weight savings, cost savings on the basis of material and manufacturing complexity, increased durability and smaller space requirements.

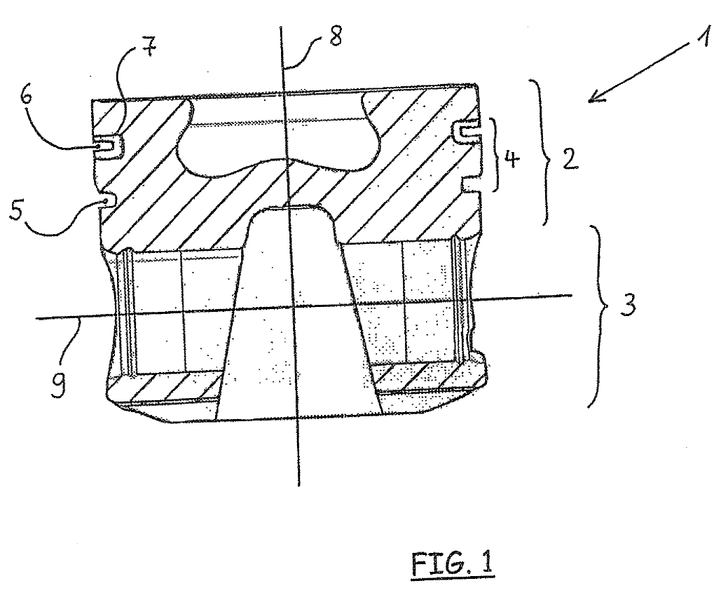

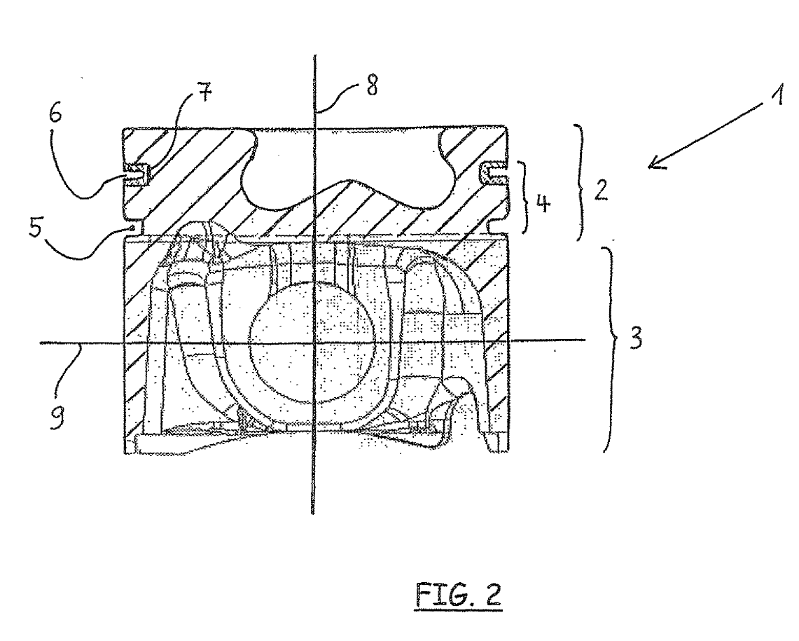

One embodiment of the invention is shown in two views in FIGS. 1 and 2, wherein a piston is given the reference numeral 1. The piston 1 consists of a piston upper part 2 and a piston lower part 3 which can be produced separately from each other and can then be joined, or the two together form a single-piece component (piston blank). The piston upper part 2 has a ring belt 4, where, depending on the design of the piston 1, there may be, but need not be, a combustion bowl coaxial within the ring belt. The piston lower part 3 has piston skirts in a known manner with which the piston 1 is guided in the cylinder of the internal combustion engine. Additionally, the piston skirts contain piston pin bores into which a piston pin can be inserted to connect with a connecting rod.

In a manner in accordance with the invention, the ring belt 4 has exactly two ring grooves, where at least the upper ring groove 6 encloses a ring carrier 7. The ring carrier 7 is a preferably single-piece component which is formed in a casting mould when the piston blank is cast, fixed in the desired position, when the casting mould is then filled with casting melt and the ring carrier is completely surrounded by the casting melt. If the ring carrier 7 consists of a steel material and the casting melt of a light-alloy material, the ring carrier 7 undergoes the Al-Fin process before insertion into the casting mould. In the same manner, a ring carrier for the lower ring groove 5 can be formed. If only the upper ring groove 6 has the ring carrier 7, the lower ring groove 5 is introduced by metal-removing machining after the piston blank is cast. Then finish machining is carried out in a known way to bring the piston blank to the desired dimension for the finished piston 1.

### REFERENCE NUMERAL LIST

1. Piston
2. Piston upper part
3. Piston lower part
4. Ring belt
5. Lower ring groove
6. Upper ring groove
7. Ring carrier
8. Piston stroke axis
9. Piston pin bore axis

1. A piston for an internal combustion engine comprising:
a piston upper part having a ring belt; and
a piston lower part;
the ring belt having exactly two ring grooves, at least an upper one of the two ring grooves enclosing a ring carrier.

2. The piston of claim 1 wherein a lower one of the two ring grooves also encloses a ring carrier.

3. The piston of claim 1 wherein the ring carrier is completely surrounded by the material of the piston upper part.

4. The piston of claim 1, wherein the ring carrier undergoes an Al-Fin process.

5. The piston of claim 1 wherein at least the piston upper part is formed of a light-alloy material.
